(19) United States
(12) Patent Application Publication
(10) Pub. No.: US 2021/0225582 A1
(43) Pub. Date: Jul. 22, 2021

(54) ELECTRIC SYSTEM HAVING AT LEAST ONE INDUCTOR WITH IMPROVED ARCHITECTURE

(71) Applicant: COMMISSARIAT A L'ÉNERGIE ATOMIQUE ET AUX ENERGIES ALTERNATIVES, Paris (FR)

(72) Inventors: Guillaume REGNAT, Grenoble Cedex 9 (FR); Guillaume LEFEVRE, Grenoble Cedex 9 (FR)

(21) Appl. No.: 17/057,975

(22) PCT Filed: May 21, 2019
(86) PCT No.: PCT/FR2019/051150

§ 371 Date: Nov. 23, 2020

(30) Foreign Application Priority Data
May 24, 2018 (FR) 1854401

(51) Int. Cl. H01F 27/36; H01F 38/14; H02J 50/70; H02J 50/10

(52) U.S. Cl. CPC H01F 27/361; H02J 50/10; H02J 50/70; H01F 38/14

(57) ABSTRACT

Disclosed is an electric system including at least a first electric circuit, an electric device, a first printed circuit board supporting the first electric circuit, a device for shielding the electric device including at least a first shielding plate attached to the first printed circuit board, the first electric circuit including at least one inductor, characterized in that the inductor includes at least one first ferromagnetic part attached to the first printed circuit board and arranged to have at least one air gap with respect to the first shielding plate in such a way as to form a magnetic circuit with it.

### TECHNICAL FIELD OF THE INVENTION

The present invention relates to an electric system having an inductor with an improved architecture. The electric system may in particular by a contactless energy transmission system, which comprises a transformer provided with a first winding and a second winding.

### STATE OF THE ART

The contactless energy transmission systems are now used in many applications to limit the wiring, reduce the bulk and facilitate the use of devices. Such solutions have for example been developed for the induction charging of electric vehicles or for the recovery of electrical energy between photovoltaic panels and the power grid.

Those contactless energy transmission systems hence use a transformer to perform the contactless transmission of energy between a first electric circuit connected to the first winding of the transformer and a second electric circuit connected to the second winding of the transformer. According to the direction of transmission of the electrical energy, the first winding and the second winding of the transformer may be the primary winding or the secondary winding of the latter. These transmission solutions commonly use one or several input smoothing inductors.

Conventionally, a smoothing inductor comprises a ferromagnetic core made of two parts that are separated from each other by at least one air gap to create a magnetic circuit. The ferromagnetic core comprises several branches and a winding made about one of its branches and connected to one of the two electric circuits of the system.

In the known systems, the smoothing inductors prove to be particularly bulky, in particular due to their ferromagnetic core. And no satisfactory and robust enough solution exists to reduce this bulk.

As the presence of these inductors is often necessary to the good operation of the contactless energy transmission system, there exists a need for their bulk to be limited to the maximum extent, while not degrading the operation of the system.

This constraint exists in a contactless energy transmission system but, more generally, it is present in any electric system that uses an inductor as described hereinabove, based on a two-part ferromagnetic core.

### Disclosure or the Invention

The invention thus relates to an electric system that comprises at least a first electric circuit, an electric device, a first printed circuit board supporting said first electric circuit, a device for shielding said electric device comprising at least one first shielding plate attached to said first printed circuit board, said first electric circuit comprising at least one inductor, said inductor comprising at least one first ferromagnetic part attached to the first printed circuit board and arranged to have at least one air gap with said first shielding plate, in such a way as to form a magnetic circuit with the latter.

According to a particular feature, said air gap of the magnetic circuit is created between a first air gap surface of said first ferromagnetic part of the inductor and a second, opposite, air gap surface, belonging to said first shielding plate, and this second air gap surface of the plate has a surface area lower than that of the total surface of the first shielding plate.

According to another particular feature, the first printed circuit board comprises at least one first electrical insulating layer to which said first shielding plate is attached.

According to a particular embodiment, the system is of the contactless energy transmission type comprising a second electric circuit, a second printed circuit board supporting the second electric circuit, a transformer forming said electric device and comprising a first winding to which said first electric circuit is connected and a second winding to which said second electric circuit is connected.

According to a particular feature, the first electric circuit and the second electric circuit comprise an input power converter and a main converter comprising said transformer, a first switching bridge connected to the first winding of the transformer and a second switching bridge connected to the second winding of the transformer.

According to another particular feature, the first printed circuit board has a first face on which said first electric circuit is made and a second face to which said first shielding plate is attached.

According to another particular feature, said first winding of the transformer is attached to said first shielding plate.

According to another particular feature, the shielding device comprises a second shielding plate attached to the second printed circuit board and said second printed circuit board has a first face to which said second shielding plate is attached and a second face on which said second electric circuit is made.

According to another particular feature, said second winding of the transformer is attached to said second shielding plate.

According to another particular feature, the second printed circuit board comprises at least one second electrical insulating layer to which said second shielding plate is attached.

### BRIEF DESCRIPTION OF THE FIGURES

Other features and advantages will appear in the following detailed description, with respect to the appended drawings listed hereinafter:

FIG. 1A schematically shows in cross-sectional view an inductor that can be used in an electric system; FIG. 1B shows in top view the principle of realization of the planar winding used in said inductor of FIG. 1A;

FIG. 2 shows an electric system such as a contactless energy transmission system;

FIG. 3 schematically shows the principle of realization of a transformer that can be used in the contactless energy transmission system of FIG. 2;

FIG. 4 shows a first embodiment of the contactless energy transmission system of FIG. 2, according to the state of the art;

FIG. 5 schematically shows some sort of electric system illustrating the principle of the invention;

FIG. 6 shows the contactless energy transmission system of FIG. 2, implementing the principle of the invention.

### DETAILED DESCRIPTION OF AT LEAST ONE EMBODIMENT

In the following of the description, the terms “higher”, “lower”, “above” and “under” or equivalent are to be understood in a non-limitative way and to be interpreted taking into account a main direction (A) drawn vertically in the drawings, in the plane of the sheet.

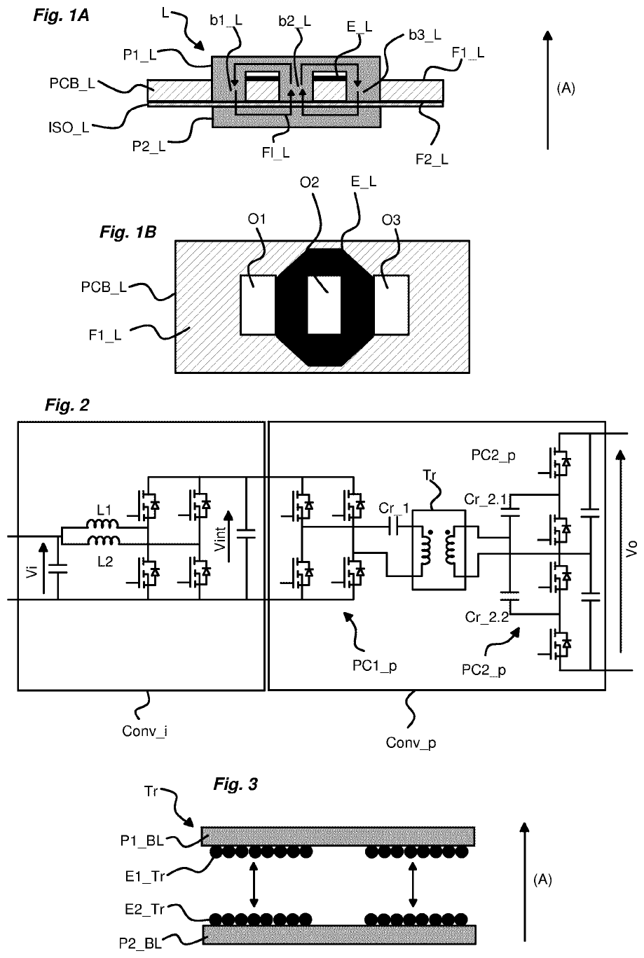

In an electric system, it is common to use an inductor L that may have various functions. The inductor L may for example be a smoothing inductor located at the input of a converter. With reference to FIGS. 1A and 1B, an inductor L may for example be consisted of a ferromagnetic core made of two parts, a so-called lower part P2_L and an upper part P1_L carrying three branches b1, b2, b3, each of the three branches being separated from the lower part by a distinct air gap. A winding E_L is wound about the central branch b2.

Such an inductor L may for example be made using two ferromagnetic parts forming the two parts of the core and a printed circuit board PCB_L on which the winding E_L is made in a planar form, i.e. in the form of conductive lines printed on the board. The board PCB_L has several openings O1, O2, O3 to let through the branches b1_L, b2_L, b3_L of the ferromagnetic core, in particular an opening intended for the passage of the central branch through the planar winding E_L made on the board. The board may comprise a lower insulating layer ISO_L forming a mechanical shim and making it possible to insulate the first part from the second part of the core and to create the magnetic air gaps between the two parts of the core. This layer is made on the lower face F2_L of the board PCB_L. The magnetic flow generated in the inductor is denoted F1_L.

This type of inductor may be used in different types of electric systems. Some of these systems are also provided with a shielding device, making it possible to protect some of their components against the electromagnetic phenomena, hence limiting the disturbances. This is for example the case of the electric systems such as the contactless energy transmission systems.

Generally, a contactless energy transmission system comprises a transformer Tr that comprises a first winding E1_Tr and a second winding E2_Tr. According to the direction of transmission of the electrical energy, the first winding E1_Tr will be its primary winding or secondary winding and, respectively, the second winding E2_Tr will be its secondary winding or its primary winding.

With reference to FIG. 3, the transformer Tr is said “contactless” when its primary and secondary windings are not placed on the same mechanical support. Many manufacturers market contactless transformers in which each winding comprises several concentric windings stuck on a shielding plate made of a magnetic material. For an efficient transfer of energy, the two windings must be arranged opposite to each other. Different solutions can be provided to adjust the relative positioning of the two windings. The two magnetic-material shielding plates P1_BL, P2_BL form a device for shielding the transformer Tr and make it possible to limit the electromagnetic disturbances and to ensure a transfer of electrical energy with a satisfactory yield. Non-limitatively, the first winding E1_Tr is attached to the lower face of the first shielding plate and the second winding E2_Tr is attached to the upper face of the second shielding plate.

The contactless energy transmission system also comprises a first electric circuit and a second electric circuit. The first electric circuit is connected to the first winding E1_Tr of the transformer and the second electric circuit is connected to the second winding E2_Tr of the latter.

To draw energy from at least one photovoltaic panel (providing an input voltage Vi), the contactless energy transmission system comprises in particular an input converter (which may be of the step-up, step-down or other type) Conv_i provided with transistors that can be controlled in such a way as to provide a maximum power (with a Maximum Power Point (MPP) searching algorithm) to a load from an input voltage Vi provided by the photovoltaic panel. In this photovoltaic application, the system further comprises a main converter Conv_p used for the contactless energy transfer. This main converter Conv_p comprises a first switching bridge PC1_p having a first series of several controlled transistors, connected, on the one hand, to the input converter to receive a so-called intermediate voltage Vint generated by the input converter and, on the other hand, to the first winding E1_Tr of the transformer, and a second switching bridge PC2_p having a second series of controlled transistors, connected on the one hand to the second winding E2_Tr of the transformer and controlled so as to provide an output voltage Vo. The main converter may be of the resonant type. It may be provided with a resonant circuit placed on the main side and/or on the secondary side. The resonant circuit can comprise one or several capacitors Cr_1, Cr_2.1, Cr_2.2 placed on the primary and/or the secondary side of the system.

The input converter Conv_i generally comprises one or several inductors L1, L2 (for example, of the smoothing type) at the input or at the output, according to its configuration. A smoothing inductance may for example have an architecture such as that described hereinabove in connection with FIGS. 1A and 1B.

With reference to FIG. 4, in a conventional manner known in the state of the art, the contactless energy transmission system is then made using three printed circuit boards:
A first printed circuit board PCB_1 that is intended for the input converter Conv_i and that has a so-called higher face F1_1 and a so-called lower, opposite face F2_1, which have identical surface areas;
A second printed circuit board PCB_2 that is intended for the first switching bridge PC1_p of the main converter and that has an upper face F1_2 and a so-called lower, opposite face F2_2, which have identical surface areas;
A third printed circuit board PCB_3 that is intended for the second switching bridge PC2_p of the main converter and that has an upper face F1_3 and a so-called lower, opposite face F2_3, which have identical surface areas.

The input converter circuit Conv_i may be made on the upper face F1_1 of the first board PCB_1 and may comprise electronic components C_1 (for example of the Surface-Mounted Component, SMC, type) welded on this upper face and electric lines printed on the upper face.

The smoothing inductors L1, L2 of the input converter Conv_i are made according to the above-described principle (FIGS. 1A and 1B) on the first printed circuit board PCB_1. For each inductor, the winding E_L1, E_L2 is formed of electric lines printed on the board PCB_1, and the three branches of the first part P1_L1, P1_L2 of the ferromagnetic core pass through the board over the thickness thereof, through suitable openings. The magnetic circuit is closed by the second part P2_L1, P2_L2 of the ferromagnetic core, positioned under the board. The magnetic flows generated in the two inductors are respectively denoted F1_L1 and F1_L2.

The circuit of the first switching bridge PC1_p of the main converter may be made on the upper face F1_2 of the second board PCB_2 and may comprise electronic components C_2 (for example of the Surface-Mounted Component, SMC, type) welded on this upper face and electric lines printed on this upper face.

The first shielding plate P1_BL, supporting the first winding E1_Tr of the transformer, is attached to the lower face of the second board.

The circuit of the second switching bridge PC2_p of the main converter may be made on the lower face F2_3 of the third board PCB_3 and may comprise electronic components C_3 (for example of the Surface-Mounted Component, SMC, type) welded on this lower face and electric lines printed on this lower face F2_3 of the third board.

The second shielding plate P2_BL supporting the second winding E2_Tr of the transformer is attached to the upper face F1_3 of the third board PCB_3, the two windings E1_Tr, E2_Tr being placed opposite to each other and separated from each other (i.e. without physical contact) to ensure the contactless energy transfer.

Electric connectors Cy may be arranged to make a physical electric bridge between the first printed circuit board and the second printed circuit board and to hence connect the input converter Conv_i to the first switching bridge PC1_p of the main converter.

The second printed circuit board PCB_2 and the third printed circuit board PCB_3 each have an electrical insulating layer ISO_2, ISO_3 against which the associated shielding plate is attached.

It is understood that this prior solution is not necessarily satisfactory, in particular in terms of bulk.

The principle of the invention consists in using the shielding device used in any electric system to close the magnetic circuit of each inductor and hence to free from using one part of the ferromagnetic core of the inductor. This principle may apply for each other inductor of the system, using the same shielding plate to close the magnetic circuit of each other inductor or using additional shielding plates of the transformer.

This principle of the invention is illustrated by FIG. 5. This FIG. 5 hence shows an electric system that comprises at least one printed circuit board PCB_x provided with an upper face F1_x and a lower face F2_x of identical surface areas. The system also comprises a first electric circuit made on the upper face of said board, comprising for example surface-mounted components C_x and electric lines printed on this upper face F1_x. The system also comprises at least one electric device D_x requiring a shielding. This electric device D_x may be a transformer, a connector or any other device liable to require a shielding. A shielding device comprises at least one shielding plate Pz_BL made of a ferromagnetic material having an upper face and a lower face. The shielding plate Px_BL is attached by its upper face to the lower face F2_x of the printed circuit board and has a surface area suitable to cover at least partially the lower face of the first printed circuit board. The electric device D_x to be shielded may be attached to the lower face of said shielding plate. To apply the principle of the invention, the first electric circuit comprises an inductor Ly (for example, a smoothing inductor or other). The winding E_Ly of this inductor is for example printed on the upper face F1_x of the printed circuit board PCB_x and the first part P1_Ly of its ferromagnetic core is passed through the openings made through the thickness of said board. The closing of its magnetic circuit is performed by the shielding plate Pz_BL and not by the second, dedicated part of its ferromagnetic core. At least one air gap is maintained between the first part P1_Ly of the ferromagnetic core and the shielding plate Pz_BL. To provide this air gap of the inductor, the printed circuit board may comprise at least one lower, electrical insulating layer ISO_x forming its lower face and to which said shielding plate is attached.

According to a particular aspect of the invention, each air gap of the magnetic circuit of the inductor is created between a first air gap surface of the first part of the core and a second air gap surface located opposite the shieling plate, this second air gap surface of the shielding plate having a surface area lower than that of the total surface of the face of the shielding plate. In other words, only a part of the shielding plate serves for the passage of the magnetic flow F1_Lx generated in the magnetic circuit of the inductor and not the totality of the plate. Said plate can moreover serve to close the magnetic circuit of one or several other inductors of the system. For an inductor of the type of FIG. 1A, which comprises three air gaps and the core first part P1_Ly of which carries three air gap surfaces, the three corresponding air gap surfaces of the shielding plate Pz_BL have, cumulated, a surface area lower than that of the total surface of the corresponding face of the shielding plate.

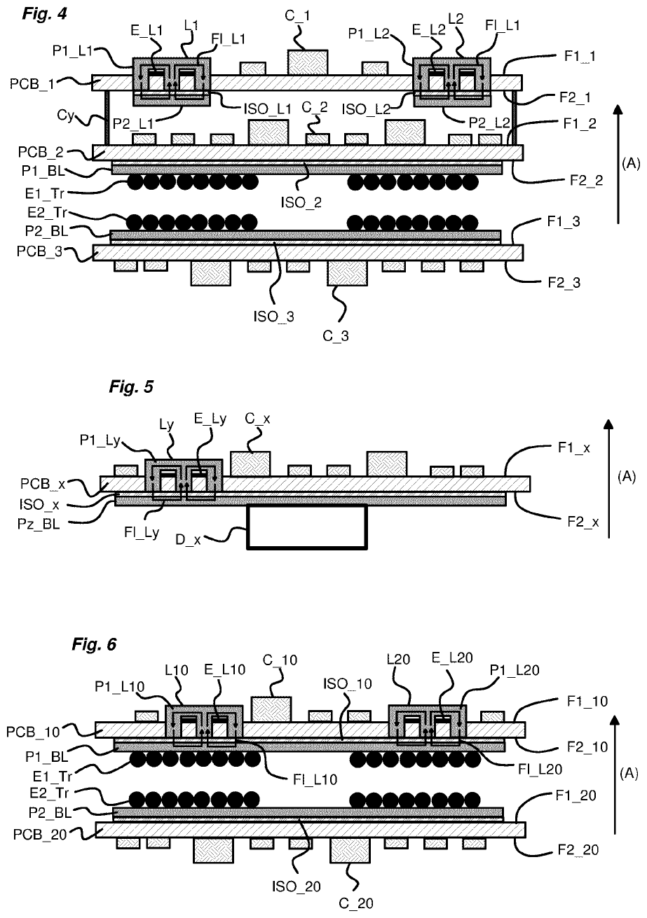

The above-described principle may apply to the contactless energy transmission system as described hereinabove. FIG. 6 shows the application of this principle to the topology of the energy transmission system described hereinabove in relation with FIG. 4.

In this embodiment, the system uses two printed circuit boards PCB_10, PCB_20 for supporting the input converter Conv_i and the two switching bridges of the main converter Conv_p. The input converter Conv_i and the first switching bridge PC1_p of the main converter are made on the upper face F1_10 of the first printed circuit board and each comprises components C_10 welded on the upper face F1_10 of this first board PCB_10 and electric lines printed on the upper face F1_10 of this board. The second switching bridge PC2_p of the main converter is made on the lower face F2_20 of the second printed circuit board and comprises components C_20 welded on the lower face F2_20 of this second board PCB_20 and electric lines printed on the lower face F2_20 of the latter. The shielding device is used to shield the transformer Tr. The first shielding plate P1_BL of the shielding device of the transformer is attached, by its upper face, to the lower face of the first printed circuit board, and advantageously occupies the whole surface thereof. The first winding E1_Tr of the transformer is attached to the lower face of this first shielding plate.

The shielding device may comprise a second shielding plate P2_BL that is attached, by its lower face, to the upper face F2_20 of the second printed circuit board PCB_20 and that advantageously occupies the whole surface of the upper face of the second printed circuit board. The second winding E2_Tr of the transformer is attached to the upper face of this second shielding plate.

The input converter Conv_i of the system comprises for example two smoothing inductors L10, L20. They each comprise a magnetic circuit made as described hereinabove, i.e. with air gaps formed between a first part P1_L10, P1_L20 of their ferromagnetic core and the first shielding plate P1_BL. The same shielding plate serves to close the magnetic circuits of the two inductors. As mentioned hereinabove, each printed circuit board has an electrical insulating layer ISO_10, ISO_20 against which the associated shielding plate is attached. The total surface of the shielding plate is hence sufficient to form several air gap surfaces, hence making it possible to close several magnetic circuits. The magnetic flows generated in the inductors are denoted F1_L10 and F1_L20.

It is understood that using the solution of the invention in such a contactless energy transmission system allows in particular eliminating a printed circuit board with respect to the conventional solution. By pooling the inductor making with the shielding solution, it is possible to combine the first printed circuit board and the second printed circuit board shown in FIG. 4 into a single one.

The inductor making solution according to the invention hence has many advantages, among which:
it is particularly little bulky because it allows using an already-present shielding plate to make the magnetic circuit of each inductor;
it is little bulky because it allows making a whole contactless energy transmission system from only two printed circuit boards;
it is easy to make because it requires no modification of the inductor structure;
it is less expensive than a conventional solution because it eliminates the use of the second part of the ferromagnetic core of each inductor.

1. An electric system comprising at least one first electric circuit, an electric device, a first printed circuit board supporting said first electric circuit, a device for shielding said electric device comprising at least one first shielding plate attached to said first printed circuit board, said first electric circuit comprising at least one inductor, wherein said inductor comprises at least one first ferromagnetic part attached to the first printed circuit board and arranged to have at least one air gap with said first shielding plate, in such a way as to form a magnetic circuit with the latter.

2. The system according to claim 1, wherein said air gap of the magnetic circuit is created between a first air gap surface of said first ferromagnetic part of the inductor and a second, opposite, air gap surface, belonging to said first shielding plate, and wherein this second air gap surface of the plate has a surface area lower than that of the total surface of the first shielding plate.

3. The system according to claim 1, wherein the first printed circuit board comprises at least one electrical insulating layer to which said first shielding plate is attached.

4. The system according to claim 1, wherein the system is of the contactless energy transmission type, comprising a second electric circuit, a second printed circuit board supporting the second electric circuit, a transformer forming said electric device and comprising a first winding to which said electric circuit is connected and a second winding to which said second electric circuit is connected.

5. The system according to claim 4, wherein the first electric circuit and the second electric circuit comprise an input power converter and a main converter comprising said transformer, a first switching bridge connected to the first winding of the transformer and a second switching bridge connected to the second winding of the transformer.

6. The system according to claim 4, wherein the first printed circuit board has a first face on which said first electric circuit is made and a second face to which said first shielding plate is attached.

7. The system according to claim 4, wherein said first winding of the transformer is attached to said first shielding plate.

8. The system according to claim 4, wherein the shielding device comprises a second shielding plate attached to the second printed circuit board and wherein said second printed circuit board has a first face to which said second shielding plate is attached and a second face on which said second electric circuit is made.

9. The system according to claim 8, wherein said second winding of the transformer is attached to said second shielding plate.

10. The system according to claim 8, wherein the second printed circuit board comprises at least one second electrical insulating layer to which said second shielding plate is attached.

11. The system according to claim 2, wherein the first printed circuit board comprises at least one electrical insulating layer to which said first shielding plate is attached.

12. The system according to claim 2, wherein the system is of the contactless energy transmission type, comprising a second electric circuit, a second printed circuit board supporting the second electric circuit, a transformer forming said electric device and comprising a first winding to which said electric circuit is connected and a second winding to which said second electric circuit is connected.

13. The system according to claim 3, wherein the system is of the contactless energy transmission type, comprising a second electric circuit, a second printed circuit board supporting the second electric circuit, a transformer forming said electric device and comprising a first winding to which said electric circuit is connected and a second winding to which said second electric circuit is connected.

14. The system according to claim 5, wherein the first printed circuit board has a first face on which said first electric circuit is made and a second face to which said first shielding plate is attached.

15. The system according to claim 5, wherein said first winding of the transformer is attached to said first shielding plate.

16. The system according to claim 6, wherein said first winding of the transformer is attached to said first shielding plate.

17. The system according to claim 5, wherein the shielding device comprises a second shielding plate attached to the second printed circuit board and in that said second printed circuit board has a first face to which said second shielding plate is attached and a second face on which said second electric circuit is made.

18. The system according to claim 6, wherein the shielding device comprises a second shielding plate attached to the second printed circuit board and in that said second printed circuit board has a first face to which said second shielding plate is attached and a second face on which said second electric circuit is made.

19. The system according to claim 7, wherein the shielding device comprises a second shielding plate attached to the second printed circuit board and in that said second printed circuit board has a first face to which said second shielding plate is attached and a second face on which said second electric circuit is made.

20. The system according to claim 9, wherein the second printed circuit board comprises at least one second electrical insulating layer to which said second shielding plate is attached.
